(19) United States
(12) Patent Application Publication
(10) Pub. No.: US 2025/0149962 A1
(43) Pub. Date: May 8, 2025

(54) CONTROL METHOD, CONTROL APPARATUS, AND OUTPUT DEVICE

(71) Applicant: Lenovo (Beijing) Limited, Beijing (CN)

(72) Inventor: Jie LI, Beijing (CN)

(21) Appl. No.: 18/939,257

(22) Filed: Nov. 6, 2024

(30) Foreign Application Priority Data
Nov. 8, 2023 (CN) 202311482222.7

(51) Int. Cl. H02M 1/00

(52) U.S. Cl. CPC H02M 1/0003; H02M 1/007; H02M 1/0083

(57) ABSTRACT

A control apparatus includes an acquisition unit and a controller. The acquisition unit is configured to obtain a first power supply parameter of a first output interface connected to a first conversion module of an output device. The controller is configured to control a second conversion module of the output device to operate according to the first power supply parameter to cause a target power supply parameter output by the second conversion module to satisfy a matching condition with the first power supply parameter. The first conversion module is configured to convert power output by the second conversion module with the target power supply parameter into power with the first power supply parameter and output the power with the first power supply parameter via the first output interface.

### CROSS REFERENCE TO RELATED APPLICATION

The present disclosure claims priority to Chinese Patent Application No. 202311482222.7, filed on Nov. 8, 2023, the entire content of which is incorporated herein by reference.

### TECHNICAL FIELD

The present disclosure is related to a control method, a control apparatus, and an output device.

### BACKGROUND

The existing output devices have multi-level conversion circuits, which are used to meet the need of power supply. However, the existing output devices are not energy efficient.

### SUMMARY

An aspect of the present disclosure provides a control apparatus including an acquisition unit and a controller. The acquisition unit is configured to obtain a first power supply parameter of a first output interface connected to a first conversion module of an output device. The controller is configured to control a second conversion module of the output device to operate according to the first power supply parameter to cause a target power supply parameter output by the second conversion module to satisfy a matching condition with the first power supply parameter. The first conversion module is configured to convert power output by the second conversion module with the target power supply parameter into power with the first power supply parameter and output the power with the first power supply parameter via the first output interface.

An aspect of the present disclosure provides an output device including a first conversion module, a second conversation module, an output apparatus, and a control apparatus. The first conversion module is configured to convert first direct current (DC) power obtained by the first conversion module into second DC power and output the second DC power. A voltage of the first DC power and a voltage of the second DC power are same or different. The second conversion module is connected to the first conversion module and configured to perform power conversion on power obtained by the output device and output the converted first DC power to the first conversion module. The power conversion includes converting alternative current (AC) into DC or DC to DC. The output apparatus is connected to the first conversion module and configured to output the second DC power output by the first conversion module. The control apparatus is connected to the first conversion module and the second conversion module and configured to control the second conversion module to operate based on a power supply parameter of the output apparatus to cause the target power supply parameter output by the second conversion module to satisfy the matching condition with the first power supply parameter.

An aspect of the present disclosure provides a control method. The method includes obtaining a power supply parameter of an output interface connected to a first conversion module of an output device and controlling a second conversion module of the output device to operate according to the power supply parameter to cause a target power supply parameter output by the second conversion module to satisfy a matching condition with the power supply parameter. The first conversion module is configured to convert first direct current (DC) power obtained by the first conversion module into second DC power and output the second DC power. The second conversion module is configured to perform power conversion on power obtained by the output device and output the converted first DC power to the first conversion module.

### BRIEF DESCRIPTION OF THE DRAWINGS

FIG. 1 illustrates a schematic structural diagram of a control apparatus according to some embodiments of the present disclosure.

FIG. 2 illustrates a schematic structural diagram of an output device according to some embodiments of the present disclosure.

FIG. 3 illustrates a schematic structural diagram of a first conversion module and an output apparatus according to some embodiments of the present disclosure.

FIG. 4 illustrates a schematic flowchart of a control method according to some embodiments of the present disclosure.

FIG. 5 illustrates a schematic logic flowchart of a control method according to some embodiments of the present disclosure.

### DETAILED DESCRIPTION OF THE EMBODIMENTS

The technical solutions of embodiments of the present disclosure are described in detail in conjunction with the accompanying drawings. Apparently, the embodiments described are merely some embodiments of the present disclosure and not all embodiments. Based on embodiments of the present disclosure, all other embodiments obtained by those skilled in the art without creative effort are within the scope of the present disclosure.

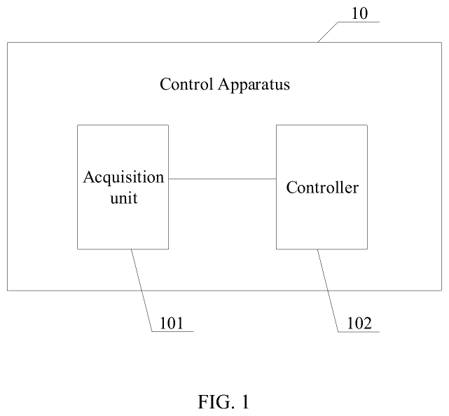

FIG. 1 illustrates a schematic structural diagram of a control apparatus 10 according to some embodiments of the present disclosure. As shown in FIG. 1, the control apparatus 10 includes an acquisition unit 101 and a controller 102.

The acquisition unit 101 can be configured to obtain the first power supply parameter of a first output interface connected to a first conversion module of an output device.

The output device can be a device that obtains power, processes the obtained power, and then outputs the processed power, such as a power adapter, charger, docking station, or monitor, which can have a power output function. The first output interface can be connected to a power-receiving device. After the power obtained by the output device is processed, the processed power can be output to the power-receiving device connected to the first output interface.

The first power supply parameter can be a power supply parameter required by the power-receiving device connected to the first output interface. For example, if the rated charging voltage of the power-receiving device is 5V, the power supply parameter can be 5V. If the rated charging voltage of the power-receiving device is 12V, the power supply parameter can be 12V. Alternatively, the first power supply parameter can be a fixed value. No matter what the rated charging voltage of the power-receiving device connected to the first output interface is, the power output by the first output interface can have a fixed first power supply parameter.

The first conversion module can be configured to convert the power parameter of the power so that the power parameter of the power obtained after the conversion can match the first power supply parameter.

The controller 102 can be configured to control a second conversion module of the output device according to the first power supply parameter to cause the target power supply parameter output by the second conversion module to satisfy a matching condition with the first power supply parameter. The first conversion module can be configured to convert the power output by the second conversion module with the target power supply parameter and output the converted power via the first output interface at the first power supply parameter.

The output power of the second conversion module can be the input power of the first conversion module. The output power of the second conversion module can correspond to the target power supply parameter, and the first conversion module can perform processing on the power with the target power supply parameter to obtain and output the power corresponding to the first power supply parameter. For example, if the first power supply parameter is 9V, i.e., the first output interface needs to output the power of 9V, the second conversion module can be controlled to output power matching 9V. Considering the voltage drop and loss during power transmission in circuits, the target power supply parameter of embodiments of the present disclosure matching the first power supply parameter can include being slightly higher than the first power supply parameter. For example, if the first power supply parameter is 20V, the target power supply parameter matching the first power supply parameter can be 21V.

The second conversion module can be configured to convert alternating current (AC) to direct current (DC) or to convert DC of a first voltage to DC of a second voltage, which is not limited in the present disclosure.

The control apparatus of embodiments of the present disclosure can control the second conversion module to operate based on the actual power output requirements of the output device to output suitable power to the first conversion module to enhance the overall power efficiency of the output device and avoid unnecessary power waste.

In some other embodiments, the first conversion module may not be only connected to the first output interface but also to other output interfaces. Thus, the acquisition unit can be also configured to obtain a second power supply parameter of the second output interface connected to the first conversion module. The controller can be configured to control the target power supply parameter of the second conversion module according to the first power supply parameter and the second power supply parameter to satisfy the matching condition with one power supply parameter of the first power supply parameter and the second power supply parameter.

When the output device needs to output two power supplies via two output interfaces, if the first power supply parameter and the second power supply parameter of the two output interfaces are the same, the target power supply parameter of the second conversion module can be directly controlled to match the first power supply parameter or the second power supply parameter. If the first power supply parameter and the second power supply parameter of the two output interfaces are different, the target power supply parameter of the second conversion module can be controlled to match one power supply parameter of the first power supply parameter and the second power supply parameter. That is, when the output interfaces have different power supply parameters, the target power supply parameter of the second conversion module may need to be ensured to match at least one of the different power supply parameters.

For example, if the first power supply parameter is 5V, and the second power supply parameter is 9V, considering the voltage drop in the circuit, the target power supply parameter of the second conversion module can be controlled to 9.5V. Then, the first conversion module can directly output the power of 9.5V to the first output interface to enable the first output interface to output the power of 9V. In addition, the first conversion module can perform voltage reduction on the power of 9.5V to obtain and output the power of 5V to the second output interface to satisfy different power supply requirements of the two output interfaces.

In embodiments of the present disclosure, when the output device includes at least two output interfaces, the target power supply parameter of the second conversion module can be controlled to ensure the target power supply parameter of the second conversion module to at least match one power supply parameter of a plurality of power supply parameters of the output interfaces. Compared to the existing solution in which the target power supply parameter does not match any of the plurality of power supply parameters, the overall energy efficiency of the output device can be improved.

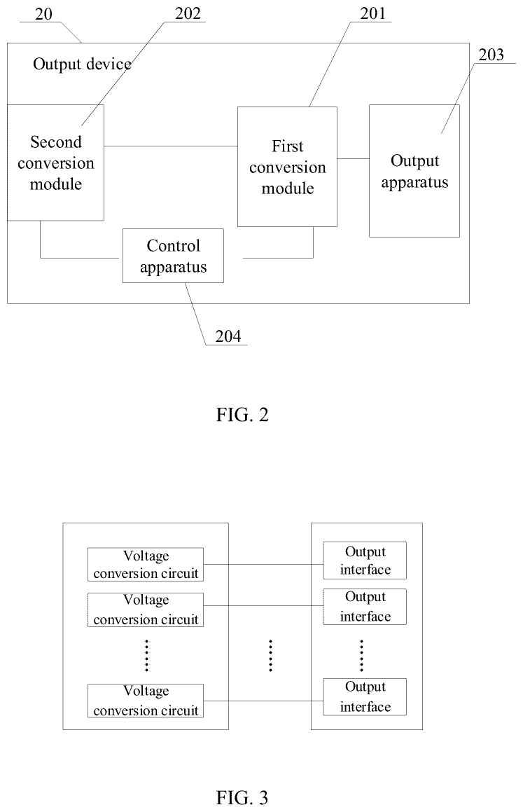

The present disclosure further provides an output device 20. FIG. 2 illustrates a schematic structural diagram of the output device 20 according to some embodiments of the present disclosure. As shown in FIG. 2, the output device 20 includes a first conversion module 201, a second conversion module 202, an output apparatus 203, and a control apparatus 204.

The first conversion module 201 can be configured to convert a first direct current (DC) obtained by the first conversion module into a second DC and output the second DC. The voltage of the first DC and the voltage of the second DC can be the same or different.

The first DC can be the output power of the second conversion module. The first conversion module can either directly transmit the obtained power or convert the voltage of the obtained DC. When the first conversion module directly transmits the obtained power, the voltage of the first DC and the voltage of the second DC can be the same or nearly the same. When the first conversion module converts the voltage of the DC, the voltage of the first DC and the voltage of the second DC can be different.

The second conversion module 202 can be connected to the first conversion module and configured to perform power conversion on the power obtained by the output device and output the converted first DC to the first conversion module. The power conversion can include converting AC to DC or converting DC to DC.

The power obtained by the second conversion module can be the power obtained by the output device from outside. The second conversion module can perform conversion on the obtained power. If the power obtained from the outside is AC, the second conversion module can be configured to convert the obtained AC to DC. If the obtained power is DC, the second conversion module can be configured to convert the DC of a third voltage to a DC of a second voltage, or directly output the DC of the third voltage as needed. The DC output by the second conversion module can be output to the first conversion module.

The output device 203 can be connected to the first conversion module and configured to output the second DC provided by the first conversion module.

The output device can be an output interface connected to the first conversion module and configured to output the DC converted by the first conversion module to a power-receiving device connected to the output interface.

The control apparatus 204 can be connected to the first conversion module and the second conversion module and configured to control the second conversion module to operate based on the power supply parameter of the output apparatus to cause the target power supply parameter output by the second conversion module to satisfy the matching condition with the first power supply parameter.

In practical applications, the control apparatus can first obtain the power supply parameter of the output apparatus connected to the first conversion module from the first conversion module, control the second conversion module to operate based on the power supply parameter to cause the output of the second conversion module to match the power with the target power supply parameter, i.e., output the power matching the power supply parameter of the output apparatus.

In some embodiments, with the configuration of the second conversion module, the control apparatus can determine a power adjustment parameter of the second conversion module based on the power supply parameter of the output apparatus and output the determined power adjustment parameter to the second conversion module. Then, the second conversion module can directly operate based on the power adjustment parameter to output the power with the target power supply parameter matching the power supply parameter of the output apparatus.

In some other embodiments, after obtaining the power supply parameter of the output apparatus, the control apparatus can transmit the power supply parameter to the second conversion module. The second conversion module can adjust the operation parameters of the second conversion module according to the obtained power and the power supply parameter to output the power with the target power supply parameter matching the power supply parameter of the output apparatus.

The output device of embodiments of the present disclosure can control the second conversion module to operate based on the actual power output requirements of the output interface to cause the second conversion module to output and provide suitable power to the first conversion module. Thus, the overall energy efficiency of the output device can be improved, and unnecessary power waste can be avoided.

FIG. 3 illustrates a schematic structural diagram of the first conversion module and the output apparatus according to some embodiments of the present disclosure. As shown in FIG. 3, the first conversion module above includes a plurality of voltage conversion circuits connected in parallel. The output apparatus includes a plurality of output interfaces. The plurality of output interfaces can be in a one-to-one correspondence with the plurality of voltage conversion circuits.

Each output interface can be connected to a power-receiving device. The rated charging voltages of the power-receiving devices connected to different interfaces can be the same or different. When the target power supply parameter of the second conversion module matches the power supply parameters of the one or more interfaces, the voltage conversion circuits connected to one or more interfaces may not perform voltage conversion. The power with the target power supply parameter output by the second conversion module can be directly provided to the one or more interfaces. When the target power supply parameter of the second conversion module does not match the power supply parameters of one or more interfaces, the voltage conversion circuits connected to the one or more interfaces may need to perform voltage conversion on the power with the target power supply parameter to cause the voltage of the power after conversion to match the voltages represented by the power supply parameters of the one or more interfaces.

In the solution of the present disclosure, since the target power supply parameter of the second conversion module is ensured to match the power supply parameter of at least one output interface, compared to the existing solution in which the target power supply parameter does not match the plurality of power supply parameters of the output interfaces, the overall energy efficiency of the output device can be improved.

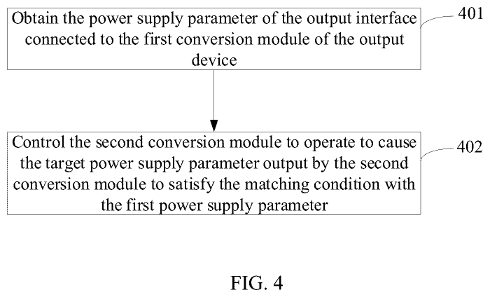

FIG. 4 illustrates a schematic flowchart of a control method according to some embodiments of the present disclosure. As shown in FIG. 4, the control method includes the following processes.

At 401, the power supply parameter of the output interface connected to the first conversion module of the output device is obtained.

The power supply parameter of the output interface can be the rated charging voltage of the power-receiving device connected to the output interface. That is, for the same output interface, the power supply parameter of the output interface can dynamically change based on the connected power-receiving device. Alternatively, the power supply parameter of the output interface can be a fixed value, which does not change when the rated charging voltage of the power-receiving device changes.

At 402, the second conversion module is controlled to operate to cause the target power supply parameter output by the second conversion module to satisfy the matching condition with the first power supply parameter.

The first conversion module can be configured to convert the first DC obtained by the first conversion module into the second DC and output the second DC. The second conversion module can be configured to convert the power obtained by the output device and output the converted first DC to the first conversion module.

The output power of the second conversion module can be the input power of the first conversion module. The output power of the second conversion module can correspond to the target power supply parameter, and the first conversion module can perform processing on the power with the power supply parameter to obtain and output the power corresponding to the power supply parameter of the output interface. In the solution of the present disclosure, the second conversion module can be controlled to operate based on the power supply parameter of the output interface to cause the second conversion module to output the power matching the target power supply parameter, i.e., output the power matching the power supply parameter of the output interface.

In the control method of embodiments of the present disclosure, the second conversion module can be controlled to operate based on the actual power output requirements of the output device to cause the second conversion module to output the suitable power for the first conversion module. The overall energy efficiency of the output device can be improved, and the unnecessary power waste can be avoided.

For example, the output device can include at least two output interfaces, the present disclosure is described below.

In some embodiments, the power supply parameters of the at least two output interfaces connected to the first conversion module of the output device can be obtained, and the second conversion module of the output device can be controlled to output the target voltage based on the power supply parameter.

In some other embodiments, the interface statuses and the power supply parameters of the at least two output interfaces can be obtained. In response to the interface statuses, the output interfaces can be indicated to be connected to power-receiving devices. The second conversion module of the output device can be controlled to output the target voltage based on the power supply parameter. The interface status can be used to indicate whether the interface is connected to a power-receiving device.

The power supply parameter above can be a preset fixed value or the rated charging parameter of the power-receiving device connected to the output interface.

Controlling the second conversion module of the output device to output the target voltage based on the power supply parameter can include, if the power supply parameters of all the output interfaces connected to the power-receiving devices of the at least two output interfaces are the same, controlling the second conversion module to output the target voltage matching the power supply parameter. For example, if the two output interfaces of the output device are connected to the power-receiving devices, respectively, and the rated charging voltages of the two power-receiving devices are 9V, the second conversion module can be controlled to output the target voltage matching 9V.

In some other embodiments, if at least two output interfaces are connected to the power-receiving devices, and the power supply parameters corresponding to the at least two output interfaces connected to the power-receiving devices are different, the second conversion module can be controlled to output the target voltage matching any one of the at least two power supply parameters. For example, the output device includes two output interfaces connected to power-receiving devices, respectively, the rated charging voltage of the first power-receiving device is 5V, and the rated charging voltage of the second power-receiving device is 12V. The second conversion module can be controlled to output the target voltage matching 5V. The first conversion module can then directly transmit the DC of 5V to the first power-receiving device and increase the DC from 5V to 12V to supply power to the second power-receiving device.

Alternatively, if at least two output interfaces are connected to power-receiving devices, and the power supply parameters of the at least two output interfaces connected to the power-receiving devices are different, the second conversion module can be controlled to output a target voltage matching the maximum value of the at least two power supply parameters. For example, the output device can include two output interfaces connected to power-receiving devices, the rated charging voltage of the first power-receiving device is 5V, and the rated charging voltage of the second power-receiving device is 9V. Then, the second conversion module can be controlled to output the target voltage matching 9V. The first conversion module can perform the voltage reduction on the obtained DC from 9V to 5V and provide the DC of 5V to the first power-receiving device and directly provide the DC of 9V to the second power-receiving device.

Alternatively, if more than two output interfaces are connected to power-receiving devices, the power supply parameter that occurs most frequently among all the power supply parameters of the output interfaces connected to the power-receiving devices can be determined as the target parameter. The second conversion module can be controlled to output the target voltage matching the target parameter. For example, the output device can include 4 output interfaces connected to the power-receiving devices, respectively. The rated charging voltage of the first power-receiving device can be 9V, the rated charging voltage of the second power-receiving device can be 5V, the rated charging voltage of the third power-receiving device can be 9V, and the rated charging voltage of the fourth power-receiving device can be 12V. Thus, the power-receiving device requiring 9V is the most frequently encountered, i.e., the power supply parameter of 9V occurs most frequently. Then, the second conversion module can be controlled to output the target voltage of 9V.

Due to the issue of voltage drops in power transmission circuits, the target voltage matching the power supply parameter can be greater than the voltage value represented by the power supply parameter. The exact amount by which the target voltage is greater than the voltage value represented by the power supply parameter can be determined in connection with the magnitude of the target voltage and the circuit structure.

In some embodiments, the control method can further include transmitting the target voltage to the first output interface, performing the voltage adjustment processing on the target voltage, and transmitting the voltage after the voltage adjustment to the second output interface. The first output interface can be an output interface corresponding to the maximum power supply parameter or an output interface with the power supply parameter being the target parameter. The second output interface can be an output interface with the power supply parameter smaller than the maximum power supply parameter or an output interface with the power supply parameter different from the target parameter.

That is, after controlling the second conversion module to output the power corresponding to the target power supply parameter based on the power supply parameter of the output interface, the first conversion module can obtain the power and directly output the power to the output interface with the power supply parameter matching the target power supply parameter. For the output interfaces with the power supply parameters not matching the target power supply parameter, the power with the target power supply parameter can be adjusted by the power adjustment circuit to the power matching the power supply parameter of the output interface for output.

Controlling the second conversion module of the output device to output the target voltage based on the power supply parameter can further include, if the at least two output interfaces are not connected to power-receiving devices, controlling the second conversion module to output a first voltage. The first voltage can be determined based on the lowest output voltage of the output interfaces.

That is, when the output interfaces of the output device are not connected to the power-receiving devices, the output device can be determined to have no actual power supply needs. The first voltage output by the second conversion module can be controlled to be the lowest output voltage of the output interfaces to reduce the power consumption.

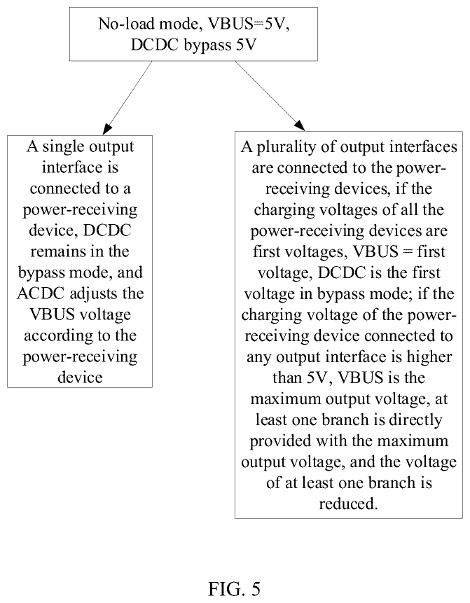

In practical applications, an execution body of the control method can be a microcontroller (MCU) in a power adapter. The power adapter can include an AC to DC conversion (ACDC) module, a DC to DC conversion (DCDC) module, and four output interfaces connected to the DCDC module. FIG. 5 illustrates a schematic logic flowchart of the control method according to some embodiments of the present disclosure. As shown in FIG. 5, when all the output interfaces are 5V, the MCU controls the ACDC module to output 5V (in actual design, the voltage can be slightly higher than 5V to compensate for voltage drops in the DCDC circuit). Then, all the output interfaces of the DCDC module can be in the bypass mode, and the DCDC efficiency can be close to 100%. Thus, the four-point average efficiency at 5V output conditions can be improved. For the plurality of ports being 9V/12V/15V/20V, the MCU can similarly control the output corresponding to the ACDC module through voltage adjustment, and the DCDC can partially remain in the bypass mode.

In a no-load mode, the ACDC module can output 5V, and the DCDC module can remain in the bypass mode (i.e., the DCDC module does not operate). Then, the no-load power consumption can only include the power consumption of the ACDC module.

In some embodiments, under the initial status, the power adapter can be in the no-load mode, the VBUS of the ACDC module can be at 5V, and the DCDC module can remain in the bypass mode. When a device is connected, the MCU can determine the number of the devices connected and determine the maximum voltages required by the devices.

The MCU can adjust the ACDC level according to the maximum output voltage of the DCDC module to cause the output voltage of the ACDC level as the maximum output voltage of the DCDC module. Then, the voltage reduction can be performed on other output voltages.

Through the control logic, at least one branch of the whole circuit is always in the bypass mode. Thus, the efficiency can be higher than the existing solution in any condition.

In method embodiments, to simplify the description, the method is described as a combination of a series of actions. However, those skilled in the art should know that the present disclosure is not limited to the order of the actions described. Thus, according to the present disclosure, some steps can be performed in other orders or simultaneously. Moreover, those skilled in the art should know that the described embodiments in the specification are some embodiments of the present disclosure, the involved actions and modules may not be necessary for the present disclosure.

Any control apparatus of embodiments of the present disclosure can include one or more processors and one or more memories. The above acquisition unit and the controller can be stored in the one or more memories as program modules. The one or more processors can be configured to perform the program modules stored in the one or more memories to implement corresponding functions.

A processors can include a core, which can be configured to call the corresponding program module in the one or more memories. One or more cores can be provided. The return visit data can be processed by adjusting the parameters of the one or more cores.

The one or more memories can include non-transitory computer-readable media, such as Random Access Memory (RAM) and/or non-volatile memory like Read-Only Memory (ROM) or flash memory (flash RAM). The one or more memories can include at least one storage chip.

In some embodiments, a computer-readable storage medium is further provided and can be directly loaded into the internal memory of the computer. The computer-readable storage medium can include software codes. The computer program can be loaded and executed by the computer to implement the steps of the control method above.

In some embodiments, a computer program product is further provided. The computer program product can be directly loaded into the internal memory of the computer and include software codes. The computer program can be loaded and executed by the computer to implement the steps of the control method above.

In the specification, embodiments of the present disclosure are described in a progressive manner. Each embodiment focuses on the differences from other embodiments. The similar or identical parts among the embodiments can be referred to each other. For the apparatus disclosed in embodiments of the present disclosure, since the apparatus corresponds to the method disclosed in embodiments of the present disclosure, the description can be simple. For the relevant part, reference can be made to the method embodiments.

In the specification, relational terms like first and second are used merely to distinguish one entity or operation from another entity or operation and do not necessarily imply any actual relationship or order among these entities or operations. Additionally, terms like “include,” “comprise,” or any variations thereof, are intended to cover non-exclusive inclusion, such that that a process, method, article, or device that includes a series of elements not only include those elements but also include other elements not explicitly listed or elements inherent to such process, method, article, or device. Without further limitation, an element defined by the phrase “includes a . . . ” does not exclude the existence of additional identical elements in the process, method, article, or device that includes the element.

The steps of the methods or algorithms described in embodiments of the present disclosure can be directly implemented in hardware, software modules executed by the processors, or a combination of thereof. The software modules can be stored in random access memory (RAM), memory, read-only memory (ROM), electrically programmable ROM (EPROM), electrically erasable programmable ROM (EEPROM), registers, hard disks, removable disks, CD-ROMs, or any other form of storage media known in the art.

The description of embodiments of the present disclosure can enable those skilled in the art to implement or use the present disclosure. Various modifications to embodiments of the present disclosure are apparent to those skilled in the art. The general principles defined herein can be implemented in other embodiments without departing from the spirit or scope of the present disclosure. Therefore, the present disclosure is not limited to the embodiments described in the specification but conforms to the widest scope consistent with the principles and novel features of the present disclosure.

What is claimed is:

1. A control apparatus comprising:
an acquisition unit configured to obtain a first power supply parameter of a first output interface connected to a first conversion module of an output device; and
a controller configured to control a second conversion module of the output device to operate according to the first power supply parameter to cause a target power supply parameter output by the second conversion module to satisfy a matching condition with the first power supply parameter, the first conversion module being configured to convert power output by the second conversion module with the target power supply parameter into power with the first power supply parameter and output the power with the first power supply parameter via the first output interface.

2. The control apparatus according to claim 1, wherein:
the acquisition unit is further configured to obtain a second power supply parameter of a second output interface connected to the first conversion module; and
the controller is configured to control the target power supply parameter of the second conversion module to satisfy the matching condition with one of the first power supply parameter and the second power supply parameter according to the first power supply parameter and the second power supply parameter.

3. The control apparatus according to claim 1, wherein:
the first conversion module is configured to convert first direct current (DC) power obtained by the first conversion module into second DC power and output the second DC power; and
the second conversion module is configured to perform power conversion on power obtained by the output device and output the converted first DC power to the first conversion module.

4. The control apparatus according to claim 1, wherein:
at least two output interfaces are provided;
the acquisition unit is further configured to:
obtain power supply parameters of the at least two output interfaces connected to the first conversion module of the output device or interface statuses and the power supply parameters of the at least two output interfaces, an interface status indicating whether an output interface is connected to a power-receiving device; and
the controller is further configured to:
control the second conversion module of the output device to output a target voltage based on the power supply parameter; or
in response to the interface status indicating that the power-receiving device is connected to the output interface, control the second conversion module of the output device to output a target voltage based on the power supply parameter.

5. The control apparatus according to claim 4, wherein the controller is further configured to:
in response to none of the at least two output interfaces are connected to a power-receiving device, control the second conversion module to output a first voltage, the first voltage being determined based on a lowest output voltage of the output interfaces.

6. The control apparatus according to claim 5, wherein the controller is further configured to:
in response to power supply parameters of output interfaces connected to power-receiving devices of the at least two output interfaces are the same, control the second conversion module to output the target voltage matching the power supply parameter;
in response to the at least two output interfaces being connected to the power-receiving devices, and the power supply parameters of the at least two output interfaces connected to the power-receiving devices being different, control the second conversion module to output the target voltage matching any one of the at least two power supply parameters;
in response to the at least two output interfaces being connected to the power-receiving devices, and the at least two power supply parameters corresponding to the at least two output interfaces connected to the power-receiving devices being different, control the second conversion module to output the target voltage matching a maximum value of the at least two power supply parameters; and/or
in response to more than two output interfaces being connected to power-receiving devices, determine a most frequent power supply parameter among power supply parameters of the more than two output interfaces connected to the power-receiving devices as a target parameter and control the second conversion module to output the target voltage matching the target parameter.

7. The control apparatus according to claim 6, wherein:
wherein the first conversion module includes voltage conversion circuits that correspond to a number of the output interfaces and are connected to the output interfaces, and the voltage conversion circuits are connected in parallel;
the controller is further configured to:
control a voltage conversion circuit connected to the first output interface to output power of the target voltage, the first output interface being an output interface having a maximum power supply parameter or an output interface with a power supply parameter as the target parameter; and
control a voltage conversion circuit connected to the second output interface to perform power conversion on the power of the target voltage and output converted power, the second output interface being an output interface with a power supply parameter smaller than the maximum power supply parameter or an output interface with a power supply parameter different from the target power supply parameter.

8. The control apparatus according to claim 1, wherein the target voltage matching the power supply parameter is greater than a voltage value represented by the power supply parameter.

9. An output device comprising:
a first conversion module configured to convert first direct current (DC) power obtained by the first conversion module into second DC power and output the second DC power, a voltage of the first DC power and a voltage of the second DC power being same or different;
a second conversion module connected to the first conversion module and configured to perform power conversion on power obtained by the output device and output the converted first DC power to the first conversion module, the power conversion including converting alternative current (AC) into DC or DC to DC;
an output apparatus connected to the first conversion module and configured to output the second DC power output by the first conversion module; and
a control apparatus connected to the first conversion module and the second conversion module and configured to control the second conversion module to operate based on a power supply parameter of the output apparatus to cause the target power supply parameter output by the second conversion module to satisfy the matching condition with the first power supply parameter.

10. The output device according to claim 9, wherein the first conversion module includes a plurality of voltage conversion circuits connected in parallel, the output apparatus includes a plurality of output interfaces, the plurality of output interfaces are in one-to-one correspondence with the plurality of voltage conversion circuits.

11. A control method comprising:
obtaining a power supply parameter of an output interface connected to a first conversion module of an output device; and
controlling a second conversion module of the output device to operate according to the power supply parameter to cause a target power supply parameter output by the second conversion module to satisfy a matching condition with the power supply parameter;
wherein:
the first conversion module is configured to convert first direct current (DC) power obtained by the first conversion module into second DC power and output the second DC power; and
the second conversion module is configured to perform power conversion on power obtained by the output device and output the converted first DC power to the first conversion module.

12. The control method according to claim 11, wherein:
at least two output interfaces are provided;
obtaining the power supply parameter of the output interface of the first conversion module of the output device includes:
obtaining power supply parameters of the at least two output interfaces connected to the first conversion module of the output device or interface statuses and the power supply parameters of the at least two output interfaces, an interface status indicating whether an output interface is connected to a power-receiving device; and
controlling an operation parameter of the second conversion module based on the power supply parameter includes:
controlling the second conversion module of the output device to output a target voltage based on the power supply parameter; or
in response to the interface status indicating that the power-receiving device is connected to the output interface, controlling the second conversion module of the output device to output a target voltage based on the power supply parameter.

13. The control method according to claim 12, wherein controlling the second conversion module of the output device to output the target voltage based on the power supply parameter includes:
in response to none of the at least two output interfaces are connected to a power-receiving device, controlling the second conversion module to output a first voltage, the first voltage being determined based on a lowest output voltage of the output interfaces.

14. The control method according to claim 12, wherein controlling the second conversion module of the output device to output the target voltage based on the power supply parameter includes any one of:
in response to power supply parameters of output interfaces connected to power-receiving devices of the at least two output interfaces are the same, controlling the second conversion module to output the target voltage matching the power supply parameter;
in response to the at least two output interfaces being connected to the power-receiving devices, and the power supply parameters of the at least two output interfaces connected to the power-receiving devices being different, controlling the second conversion module to output the target voltage matching any one of the at least two power supply parameters;
in response to the at least two output interfaces being connected to the power-receiving devices, and the at least two power supply parameters corresponding to the at least two output interfaces connected to the power-receiving devices being different, controlling the second conversion module to output the target voltage matching a maximum value of the at least two power supply parameters; and
in response to more than two output interfaces being connected to power-receiving devices, determining a most frequent power supply parameter among power supply parameters of the more than two output interfaces connected to the power-receiving devices as a target parameter and controlling the second conversion module to output the target voltage matching the target parameter.

15. The control method according to claim 14, wherein:
wherein the first conversion module includes voltage conversion circuits that correspond to a number of the output interfaces and are connected to the output interfaces, and the voltage conversion circuits are connected in parallel;
the method further includes:
controlling a voltage conversion circuit connected to the first output interface to output power of the target voltage, the first output interface being an output interface having a maximum power supply parameter or an output interface with a power supply parameter as the target parameter; and
controlling a voltage conversion circuit connected to the second output interface to perform power conversion on the power of the target voltage and output converted power, the second output interface being an output interface with a power supply parameter smaller than the maximum power supply parameter or an output interface with a power supply parameter different from the target power supply parameter.

16. The control method according to claim 11. wherein the target voltage matching the power supply parameter is greater than a voltage value represented by the power supply parameter.
